(19) United States
(12) Patent Application Publication
(10) Pub. No.: US 2012/0237837 A1
(43) Pub. Date: Sep. 20, 2012

(54) ADDITIVES FOR IMPROVING THE HIGH TEMPERATURE PERFORMANCE IN NON-AQUEOUS RECHARGEABLE LITHIUM-ION BATTERIES

(75) Inventors: Yong-Shou LIN, Pitt Meadows (CA); Li FENG, Coquitlam (CA)

(73) Assignees: E-ONE MOLI ENERGY (CANADA) LIMITED, B.C. (CA); E-ONE MOLI ENERGY CORPORATION, Tainan County (TW)

(21) Appl. No.: 13/050,992

(22) Filed: Mar. 18, 2011

(51) Int. Cl. H01M 10/02

(52) U.S. Cl. 429/338; 429/188; 429/199; 429/342; 429/339; 429/337; 429/341; 429/343

(57) ABSTRACT

The present invention generally relates to electrochemical batteries, and more specifically, to the combined additives in the non-aqueous electrolyte for rechargeable lithium-ion batteries containing spinel-based cathode that may enhance the performance of the batteries. The mixed additives comprising of 1,8-bis(dialkylamino)naphthalene, wherein alky group is described by CₙH₂ₙ₊₁, n=1 to 3, and vinylene carbonate (VC) are added to the electrolyte of the lithium-ion batteries greatly improve the capacity recovery and reduce AC impedance growth during the high temperature storage. The incorporation of the two kinds of additives within the electrolyte of the battery can also improve the high temperature cycling performance.

### TECHNICAL FIELD

The present invention generally relates to the field of lithium-ion batteries, and particularly to the combined additives for improving the high temperature performance in non-aqueous rechargeable lithium-ion batteries.

### BACKGROUND OF THE INVENTION

Rechargeable lithium-ion batteries have been widely used as high energy density sources in many consumer electronics applications, such as portable phones, camcorders, notebook computers and other electronic devices. Meanwhile, research and development on lithium-ion batteries are being extensively carried out in order to meet high power density requirements for new application fields such as power tool, electric vehicle (EV), hybrid electric vehicle (HEV) and plug-in hybrid electric vehicle (PHEV).

The important factors of lithium-ion batteries as higher power sources are internal impedance, high-temperature stability and operational lifetime from point of technical view. Impedance growth and capacity loss of lithium-ion batteries at elevated temperatures or in long lifetime are mainly attributed to the continued chemical and/or electrochemical reactions among the electrolyte components (solvents, salt and traces of impurities), anode and cathode materials. The reaction products make a passivation film on anode surface, usually called solid electrolyte interface (SEI) composed of LiF, Li₂CO₃, (CH₂OCO₂Li)₂, ROLi, ROCO₂Li, etc. At normal conditions, the porous SEI film can prevent from further side reactions among electrolyte components and traces of impurity on fresh carbon surface and makes a lithium-ion battery have a longer cycle life. However, this film is usually not thermally stable, especially at higher temperatures. The porous SEI can be damaged physically or become thicker due to continued reactions mentioned above, resulting in electrode impedance increase and battery performance deterioration.

Non-aqueous electrolyte for lithium-ion batteries is mainly composed of organic solvents, salt and additive(s). The solvents include cyclic carbonate, linear carbonates or the like, such as ethylene carbonate (EC), propylene carbonate (PC), fluorethylene carbonate (FEC), dimethyl carbonate (DMC), diethyl carbonate (DEC), and ethyl methyl carbonate (EMC), and salt is selected from LiPF₆, LiBF₄, LiN(CF₃SO₂)₂, lithium bisoxalatoborate (LiBOB), LiAsF₆, etc. The SEI films are formed and thickened by electrical reduction or/and chemical reactions on the electrode surface.

In some cases, an additive such as an organic compound may be incorporated into the electrolyte and effectively interact with at least one component or species of the battery to improve battery performance by modifying the passivation film composition and structure with improved thermal and mechanical stability during battery charge and discharge. Therefore, continued chemical side reactions on the electrode surface can be efficiently reduced, especially at elevated temperatures. For example, U.S. Pat. No. 5,626,981 discloses that vinylene carbonate (VC) was added as electrolyte additive to form a stable SEI and improve battery performance.

U.S. Patent Application No. 20090035646 discloses one chemical compound selected from the group consisting of six-membered aromatic rings comprising at least one nitrogen atom as electrolyte additive in lithium metal battery to reduce soft pouch battery swelling. Chinese Patent Application No. 200810067807.1 discloses that the naphthalene derivative additive can improve battery overcharge safety, high temperature cycling performance, and rate capability in the prismatic lithium-ion batteries using LiCoO₂ as cathode active material. Japan Patent Application No. 11-269196 discloses that the high temperature cycling performance of the battery can be improved when non-aqueous electrolyte contains one of 1,8-bis(dialkylamino)naphthalene compounds as additive with LiCoO₂ cathode material.

It is important to reduce the capacity loss and suppress the battery impedance growth during high temperature storage and cycling in lithium-ion batteries, especially in power applications. The incorporation of a combination of two additives within the electrolyte of the battery has been achieved, in accordance with the invention, to reduce the battery impedance growth during high temperature storage and to improve storage and cycling performances of the battery, especially at elevated temperatures.

### SUMMARY

The object of the present invention is to solve the above-described problems and to provide a non-aqueous electrolyte solution that can reduce capacity loss and impedance growth during high temperature storage, as well as improve the high temperature cycling performance. The present invention is useful in a wide variety of electrochemical devices.

The present invention provides an electrolyte for a rechargeable lithium-ion battery using spinel or a mixture of spinel with other lithium-transition metal complex oxides as cathode active material that shows excellent storage and cycle life characteristics due to reduced resistance growth at high temperature. According to an embodiment of the present invention, provided is an electrolyte for a rechargeable lithium battery that includes the combined additives being capable of increasing thermal stability of electrodes within a battery, for example, by modifying the formation mechanism of the electrode surface film, and/or by reducing deposition of impurities because of some unnecessary side reactions, and finally reducing surface film impedance growth.

Examples of the lithium-ion batteries using the electrolyte containing combined additives include a pure spinel Li₁₊ₓMn₂₋ₓO₄ or a blend of spinel and Li(Ni_{1/3}Mn_{1/3}Co_{1/3})O₂, as a cathode active material and carbonaceous material, as a anode active material. The compounds represented of the combined additives are 1,8-bis(dialkylamino)naphthalene as shown in Formula 1, wherein alky is expressed as CₙH₂ₙ₊₁, n=1 to 3, and vinylene carbonate for great improvement of high temperature performance of the battery.

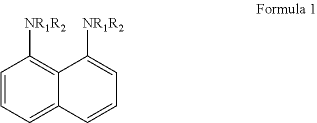

Adding 0.01˜2.0 wt % of 1,8-bis(dimethylamino)naphthalene (proton-sponge) to the non-aqueous lithium-ion battery electrolyte comprising of 1.0M LiPF₆ in a mixture of EC, PC, and DMC in a volume ratio of 2/1/3 in 18650 type of lithium-ion batteries can suppress the capacity loss and AC impedance growth during high temperature storage, as well as improve the cycling performance. Mentioned battery can be a pure spinel cathode or a blend of spinel and Li(Ni_{1/3}Mn_{1/3}Co_{1/3})O₂ cathode against graphite anode with the non-aqueous electrolyte. AC impedance measurement is executed as a sine wave (1 kHz) is applied on the battery.

Adding 0.1˜5.0 wt % of vinylene carbonate to the non-aqueous lithium-ion battery electrolyte comprising of 1.0M LiPF₆ in a mixture of EC, PC, and DMC in a volume ratio of 2/1/3 in 18650 type of lithium-ion batteries can reduce the capacity loss and AC impedance growth during high temperature, as well as improve the cycling performance. Mentioned battery can be a pure spinel cathode or a blend of spinel and Li(Ni_{1/3}Mn_{1/3}Co_{1/3})O₂ cathode against graphite anode with the non-aqueous electrolyte.

Adding both additives of 0.01˜2.0 wt % of 1,8-bis(dimethylamino)naphthalene and 0.1˜5.0 wt % of vinylene carbonate to the electrolyte of lithium-ion batteries containing 1.0M LiPF₆ in a mixture of EC, PC, and DMC in a volume ratio of 2/1/3 can greatly suppress the capacity loss and AC impedance growth during high temperature storage, and improve the cycling performance.

The invention is useful in greatly improving the high temperature storage and cycling of the batteries using spinel or spinel-blended with a secondary lithium-transition metal oxide as cathode material, as both of 1,8-bis(dimethylamino)naphthalene and VC are used together as electrolyte additives.

### BRIEF DESCRIPTION OF THE DRAWINGS

FIG. 1 shows a cylindrical lithium-ion battery of one embodiment of the present invention.

### DETAILED DESCRIPTION OF THE INVENTION

One embodiment of the present invention provides an electrolyte for lithium-ion batteries that shows excellent output characteristics due to reducing the impedance at elevated temperature. According to an embodiment of the present invention, provided is an electrolyte for a rechargeable lithium-ion battery that includes the combination of two kinds of additives. The additive may be any species capable of reducing impedance growth of electrodes within a battery, for example, by modifying surface film structure within the battery, and/or by improving stability of the surface film thickness of the electrodes.

Examples of the compounds represented of additives include 1,8-bis(dimethylamino)naphthalene and vinylene carbonate.

Adding the combined additives of 0.01˜2.0 wt % of 1,8-bis(dimethylamino)naphthalene and 0.1˜5.0 wt % of vinylene carbonate to the non-aqueous lithium-ion battery electrolyte containing 1.0M LiPF₆ in EC, PC, DMC (2/1/3 in a volume ratio) mixed solvents can obviously reduce the capacity loss and impedance growth during high temperature storage. Cycling performance fade can be also greatly improved at high temperature. Mentioned battery can be a pure spinel or a blend of spinel and Li(Ni_{1/3}Mn_{1/3}Co_{1/3})O₂ cathode against graphite anode with the non-aqueous electrolyte.

Adding 0.01˜2.0 wt % of 1,8-bis(dimethylamino)naphthalene to the non-aqueous lithium-ion battery electrolyte containing 1.0M LiPF₆ in EC, PC, DMC (2/1/3 in a volume ratio) mixed solvents can suppress the capacity loss and impedance growth during high temperature storage, as well as improve cycling performance. Mentioned battery can be a pure spinel or a blend of spinel and Li(Ni_{1/3}Mn_{1/3}CO_{1/3})O₂ cathode against graphite anode with the non-aqueous electrolyte.

Adding 0.1˜5.0 wt % of vinylene carbonate to the non-aqueous lithium-ion battery electrolyte containing 1.0M LiPF₆ in EC, PC, DMC (2/1/3 in a volume ratio) mixed solvents can suppress the capacity loss and impedance growth during high temperature storage, as well as improve the cycling performance. Mentioned battery can be a pure spinel or a blend of spinel and Li(Ni_{1/3}Mn_{1/3}Co_{1/3})O₂ cathode against graphite anode with the non-aqueous electrolyte.

The invention is useful in improving high-temperature storage and cycling properties of spinel and spinel-formulated batteries. No one else has demonstrated the applications of the combined additives of 1,8-bis(dialkylamino)naphthalene and vinylene carbonate in 18650-type cylindrical batteries using spinel or the blend of spinel and lithium-transition metal complex oxide as cathode material.

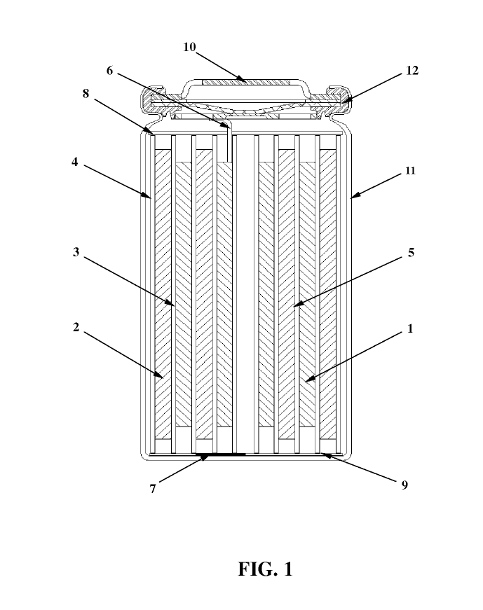

The following experimental examples demonstrate the present invention, but should not limit the scope of the present invention. 18650-size (18 mm diameter and 650 mm height) cylindrical lithium-ion battery was fabricated in the proceeding and shown in FIG. 1. Cathode 1 was composed of a pure spinel Li₁₊ₓMn₂₋ₓO₄ or a blend of spinel and Li(Ni_{1/3}Mn_{1/3}Co_{1/3})O₂ lithium-transition metal complex oxide powder, a conductive additive, and polyvinylidene fluoride (PVDF) binder containing NMP solvent. This mixture was made in the form of slurry, and then uniformly coated on both sides of a thin aluminum foil. Anode 2 comprised of a mixture of treated graphite powders, a conductive additive, and polyvinylidene fluoride (PVDF) binder containing NMP solvent. It was uniformly coated on a thin copper foil. Both electrodes were dried at high temperature for removal of NMP solvent remaining. Separator 3 was polypropylene polyethylene film. The jellyroll 4 was placed into the 18650-size can. The electrolyte 5 comprised of LiPF₆ salt and organic solvents combined with ethylene carbonate (EC), propylene carbonate (PC), dimethyl carbonate (DMC) in a volume ratio of 2/1/3, and different amount of the combined additives presented by Formula I and vinylene carbonate (VC). Cathode tab 6 and anode tab 7 were connected to the header 10 and can 11, respectively. Insulating pieces 8 and 9 were used to prevent the possibility of internal shorting. Gasket 12 was used for purposes of insulation and sealing.

For electrical testing, the batteries were first conditioned by charging, discharging, and charging again up to 4.2V at room temperature. After three day aging, batteries were cycled at 23° C. for 3 cycles with C-rate discharge/charge between 4.2V-2.0V and stopped at fully charge state (100% SOC). The batteries were then stored at 60° C. for 28 days, followed by C-rate discharging, charging, and discharging at 23° C. The capacity recovery in percentage was calculated by dividing the 2^{nd} discharge capacity after storage by the 3^{rd} cycle discharge capacity before storage. AC impedance growth in percentage was also calculated from the measurements taken before and after the storage. Battery cycling tests were performed at 45° C. with C-rate charge and discharge in a voltage range of 4.2V-2.0V.

### Battery Examples

A series of 18650 batteries was assembled as described above wherein different amounts of additives were incorporated into the electrolyte systems. Tables 1 and 3 give the experimental examples of the invention in regards to capacity recovery and AC impedance growth of the batteries after 28 days storage at 60° C. of two kinds of batteries fabricated using pure spinel cathode and a blend of spinel and Li(Ni_{1/3}Mn_{1/3}Co_{1/3})O₂ cathode, respectively. Tables 2 and 4 present the discharge capacity retention after 500 cycles at 45° C. of two kinds of batteries fabricated using pure spinel cathode and a blend of spinel and Li(Ni_{1/3}Mn_{1/3}Co_{1/3})O₂ cathode, respectively. The batteries with electrolyte containing the combination of the additives of 1,8-bis(dimethylamino)naphthalene and vinylene carbonate were used as examples. For purposes of comparison, batteries were also made without any additive and with one additive vinylene carbonate or 1,8-bis(dimethylamino)naphthalene only, respectively. All test data in the tables are averaged from two identical batteries of each test.

### Example 1

Combined additives of 0.5 wt % of 1,8-bis(dimethylamino)naphthalene and 2.0% of vinylene carbonate were added into the mixed solvents of EC, PC and DMC (2/1/3 in a volume ratio) with dissolved 1.0M LiPF₆ salt in the spinel cathode batteries. The capacity recovery and impedance growth are listed in Table 1 for the fully charged batteries containing the electrolyte solution after storing at 60° C. for 28 days. Table 2 shows the discharge capacity retention of the batteries after cycling at C-rate for 500 cycles at 45° C.

TABLE 1

| Example | | Additive | Capacity | ACZ (mohm) | ACZ (mohm) |
|---|---|---|---|---|---|
| number | Additive | Amount (wt %) | Recovery (%) | Before storage | After storage |
| Example 1 | Proton-sponge + VC | 0.5 + 2.0 | 80.5 | 14.0 | 26.0 |
| Example 2 | Proton-sponge + VC | 1.0 + 2.0 | 79.2 | 14.0 | 28.0 |
| Comparative | None | None | 70.2 | 14.0 | 43.5 |
| Example 1 | | | | | |
| Comparative | Proton-sponge | 1.0 | 75.7 | 14.0 | 38.0 |
| Example 2 | | | | | |
| Comparative | VC | 2.0 | 75.1 | 14.0 | 29.5 |
| Example 3 | | | | | |

TABLE 2

| Example | | Additive | Capacity retention |
|---|---|---|---|
| number | Additive | Amount (wt %) | after 500 cycles (%) |
| Example 1 | Proton-sponge + VC | 0.5 + 2.0 | 80.4 |
| Example 2 | Proton-sponge + VC | 1.0 + 2.0 | 79.5 |
| Comparative | None | None | 64.0 |
| Example 1 | | | |
| Comparative | Proton-sponge | 1.0 | 65.8 |
| Example 2 | | | |
| Comparative | VC | 2.0 | 79.4 |
| Example 3 | | | |

### Example 2

1.0 wt % of 1,8-bis(dimethylamino)naphthalene together with 2.0% of vinylene carbonate were added into mixed solvents of EC, PC and DMC (2/1/3 in a volume ratio) with dissolved 1.0M LiPF₆ salt in the spinel cathode batteries. Table 1 presents the capacity recovery and impedance growth for the fully charged batteries containing the electrolyte solution after storing at 60° C. for 28 days. The discharge capacity retention of the batteries after cycling at C-rate for 500 cycles at 45° C. is shown in Table 2.

### Comparative Example 1

In Comparative Example 1, none of the additive was added into the mixed solvents of EC, PC and DMC (2/1/3 in a volume ratio) with dissolved 1.0M LiPF₆ salt in the spinel cathode batteries. The fully charged batteries containing the electrolyte solution were stored for 28 days at 60° C. and the corresponding capacity recovery and impedance growth are presented in Table 1. Table 2 shows the capacity retention after cycling the batteries at C-rate for 500 cycles at 45° C.

### Comparative Example 2

In Comparative Example 2, 1.0 wt % of 1,8-bis(dimethylamino)naphthalene was added into the mixed solvents of EC, PC and DMC (2/1/3 in a volume ratio) with dissolved 1.0M LiPF₆ salt in the spinel cathode batteries. Table 1 shows the capacity recovery and impedance growth of the fully charged batteries with the electrolyte solution after high temperature storage. The capacity retention of the batteries after 500 cycles at 45° C. is listed in Table 2.

### Comparative Example 3

In Comparative Example 3, 2.0 wt % of vinylene carbonate was added in the electrolyte comprising of the mixed solvents of EC, PC and DMC (2/1/3 in a volume ratio) with dissolved 1.0M LiPF₆ salt in the spinel cathode batteries. In Table 1, it presents the capacity recovery and impedance growth of the batteries containing the electrolyte solution after high temperature storage for 28 days. The capacity retention of the batteries after 500 cycles at 45° C. is shown in Table 2.

### Example 3

In Example 3, the combined additives of 0.5 wt % of 1,8-bis(dimethylamino)naphthalene and 2.0 wt % of vinylene carbonate were added into the electrolyte comprising of 1.0M LiPF₆ in EC, PC, DMC (2/1/3 in a volume ratio) mixed solvents in the batteries with a blend of spinel and LiNi_{1/3}Mn_{1/3}Co_{1/3}O₂ as cathode material. The batteries containing the electrolyte solution were stored at 60° C. for 28 days at the state of charge of 100%. In Table 3, it shows the corresponding capacity recovery and impedance growth, and the capacity retention after cycling the batteries at C-rate for 500 cycles at 45° C. is listed in Table 4.

TABLE 3

| Example | | Additive | Capacity | ACZ (mohm) | ACZ (mohm) |
|---|---|---|---|---|---|
| number | Additive | Amount (wt %) | Recovery (%) | Before storage | After storage |
| Example 3 | Proton-sponge + VC | 0.5 + 2.0 | 84.1 | 13.0 | 28.0 |
| Example 4 | Proton-sponge + VC | 1.0 + 2.0 | 84.2 | 13.0 | 29.5 |
| Comparative | None | None | 73.2 | 13.0 | 42.5 |
| Example 4 | | | | | |
| Comparative | Proton-sponge | 1.0 | 79.5 | 13.0 | 43.0 |
| Example 5 | | | | | |
| Comparative | VC | 2.0 | 79.3 | 12.0 | 31.5 |
| Example 6 | | | | | |

TABLE 4

| Example | | Additive | Capacity retention |
|---|---|---|---|
| number | Additive | Amount (wt %) | after 500 cycles (%) |
| Example 3 | Proton-sponge + VC | 0.5 + 2.0 | 87.3 |
| Example 4 | Proton-sponge + VC | 1.0 + 2.0 | 87.2 |
| Comparative | None | None | 78.9 |
| Example 4 | | | |
| Comparative | Proton-sponge | 1.0 | 79.8 |
| Example 5 | | | |
| Comparative | VC | 2.0 | 86.3 |
| Example 6 | | | |

### Example 4

The combined additives of 1.0 wt % of 1,8-bis(dimethylamino)naphthalene and 2.0 wt % of vinylene carbonate were added into the electrolyte comprising of 1.0M LiPF₆ in EC, PC, DMC (2/1/3 in a volume ratio) mixed solvents in the batteries with a blend of spinel and LiNi_{1/3}Mn_{1/3}CO_{1/3}O₂ as cathode material. The fully charged batteries containing the electrolyte solution were stored at 60° C. for 28 days. In Table 3, it presents the corresponding capacity recovery and impedance growth, and the capacity retention after cycling the batteries at C-rate for 500 cycles at 45° C. is listed in Table 4.

### Comparative Example 4

No additive was added into the electrolyte comprising of the mixed solvents of EC, PC and DMC (2/1/3 in a volume ratio) with dissolved 1.0M LiPF₆ salt in the batteries with a blend of spinel and LiNi_{1/3}Mn_{1/3}Co_{1/3}O₂ as cathode material. The fully charged batteries were stored at 60° C. for 28 days and the corresponding capacity recovery and impedance growth are presented in Table 3. The capacity retention of the batteries after 500 cycles at 45° C. is listed in Table 4.

### Comparative Example 5

In Comparative Example 5, 1.0 wt % of the additive 1,8-bis(dimethylamino)naphthalene was added into the mixed solvents of EC, PC and DMC (2/1/3 in a volume ratio) with dissolved 1.0M LiPF₆ salt in the batteries with a blend of spinel and LiNi_{1/3}Mn_{1/3}Co_{1/3}O₂ as cathode material. The batteries containing the electrolyte solution were stored at 60° C. for 28 days and the corresponding capacity recovery and impedance growth after the storage are listed in Table 3 and the capacity retention after 500 cycles at 45° C. is listed in Table 4.

### Comparative Example 6

In Comparative Example 6, 2.0 wt % of vinylene carbonate additive was added into the mixed solvents of EC, PC and DMC (2/1/3 in a volume ratio) with dissolved 1.0M LiPF₆ salt in the batteries with a blend of spinel and LiNi_{1/3}Mn_{1/3}Co_{1/3}O2 as cathode material. The batteries containing the electrolyte solution were stored at 60° C. for 28 days and the corresponding capacity recovery and impedance growth after the storage are listed in Table 3. The capacity retention after 500 cycles at 45° C. is listed in Table 4.

As shown in Table 1 in the case of spinel was used as cathode material, after 60° C. storage for 28 days the capacity recoveries in percentage are obviously higher in Examples 1 & 2, in which the batteries were assembled with the electrolyte containing the combined additives of 1,8-bis(dimethylamino)naphthalene and vinylene carbonate, compared to the Comparative Examples 1, 2, and 3, in which the batteries were assembled with the electrolyte containing no additive or one additive only.

In spinel battery, the combination of two additives 1,8-bis(dimethylamino)naphthalene and vinylene carbonate gave the best efficiency for suppressing the battery AC impedance growth during 60° C. storage test as showed in Table 1, whereas battery without additive in electrolyte has worse AC impedance growth and with one single additive has moderate improvement only.

Table 2 summarizes the comparison of 45° C. cycling performances in the batteries with spinel as cathode material among the different combinations of electrolyte additives. The batteries with combined additives gave the highest capacity retention after 500 cycles compared to those without additive or one additive alone.

The high temperature storage and cycling performance improvements have been examined further on the batteries using a blend of spinel and Li(Ni_{1/3}Mn_{1/3}Co_{1/3})O₂ cathode and electrolyte solution with and without additives. The batteries in Examples 3 and 4 with electrolyte containing different amounts of the combined additives of 1,8-bis(dimethylamino)naphthalene and vinylene carbonate have higher capacity recovery and less AC impedance growth in 60° C. storage test for 28 days compared to those batteries in Comparative Examples 4, 5, and 6 with one electrolyte additive only or without additive as summarized in Table 3.

The capacity retentions after 500 cycles with C-rate at 45° C. in the batteries with a blended cathode material are compared in Table 4. Again, the batteries with electrolyte containing two electrolyte additives have the highest capacity retention among the tests, and the batteries without electrolyte additive has the lowest capacity retention.

As a result, it is concluded that the battery with the combination of additives 1,8-bis(dimethylamino)naphthalene and vinylene carbonate demonstrates the best high temperature performance improvements compared to batteries with one additive only or without additive in the electrolyte.

It is believed that the combined additives of the present invention and many of the attendant advantages will be understood by the foregoing description. It is also believed that it will be apparent that various changes may be made in the form, construction and arrangement of the components thereof without departing from the scope and spirit of the invention or without sacrificing all of the material advantages. The form herein before described being merely an explanatory embodiment thereof. It is the intention of the following claims to encompass and include such changes.

What is claimed is:

1. A non-aqueous rechargeable lithium-ion battery, comprising:
an anode including an active material capable of reversibly intercalating and deintercalating lithium-ion, or lithium compound anode;
a cathode containing an active material capable of reversibly intercalating and deintercalating lithium-ion;
a non-aqueous electrolyte containing organic solvents, lithium salt and the combined first additive comprising 1,8-bis(dialkylamino)naphthalene as shown in Formula 1, wherein alky is expressed as CₙH₂ₙ₊₁, n=1 to 3,
and the second additive comprising vinylene carbonate with molecular formula C₃H₂O₃.

2. The non-aqueous rechargeable lithium-ion battery of claim 1, wherein the first additive in the combined additives has an amount of 0.01 to 2.0 wt % in the electrolyte.

3. The non-aqueous rechargeable lithium-ion battery of claim 1, wherein the second additive in the combined additives has an amount of 0.1 to 5.0 wt % in the electrolyte.

4. The non-aqueous rechargeable lithium-ion battery of claim 1, wherein the first additive is 1,8-bis(dimethylamino)naphthalene.

5. The non-aqueous rechargeable lithium-ion battery of claim 1, wherein the combined additives include 0.5˜1.0 wt % of the first additive and 1.0˜3.0 wt % of the second additive.

6. The non-aqueous rechargeable lithium-ion battery of claim 1, wherein the lithium salt comprises at least one selected from LiPF₆, LiBF₄, LiN(CF₃SO₂)₂, LiBOB, or their mixtures.

7. The non-aqueous rechargeable lithium-ion battery of claim 1, wherein the electrolyte comprises a mixture of two or more solvents selected from ethylene carbonate, propylene carbonate, dimethyl carbonate, ethyl methyl carbonate, diethyl carbonate, fluoroethylene carbonate, dimethyl formamide, r-butyrolactone, acetonitrile, dimethyl sulfoxide, ethyl acetate, and methyl acetate.

8. An non-aqueous rechargeable lithium-ion battery, comprising a cathode including a cathode active material capable of reversibly intercalating and deintercalating lithium-ion, an anode including an anode active material capable of reversibly intercalating and deintercalating lithium-ion, and an electrolyte containing the combined additives of 1,8-bis(dimethylamino)naphthalene and vinylene carbonate.

9. The non-aqueous rechargeable lithium-ion battery of claim 8, wherein the cathode active material is one selected from lithium-transition metal oxide compounds or their mixtures.

10. The non-aqueous rechargeable lithium-ion battery of claim 9, wherein the lithium-transition metal oxide compounds are selected from Li₁₊ₓMn_{2-x-y}M_{y}O₄ (M=one or more metal ions selected from Co, Al, Mg, Cr, Cu, Zn, Ni, etc., 0≦x≦⅓, 0≦y≦0.2), LiCoO₂, Li₁₊ₓNiₐMn_{b}Co_{c}O₂ (0≦x≦0.1, 0≦a≦0.9, 0≦b≦0.5, 0≦c≦0.5), LiNiₓ Co_{y} Al_{z} O₂ (0.5≦x≦1.0, 0≦y≦0.5, 0≦z≦0.1), and LiFePO₄.

11. The non-aqueous rechargeable lithium-ion battery of claim 8, wherein the cathode active material is one selected from Li₁₊ₓMn_{2-x-y}M_{y}O₄ (M=one or more metal ions selected from Co, Al, Mg, Cr, Cu, Zn, Ni, etc., 0≦x≦⅓, 0≦y≦0.2), Li₁₊ₓNiₐMn_{b}Co_{c}O₂ (0≦x≦0.1, 0≦a≦0.9, 0≦b≦0.5, 0≦c≦0.5), and Li₁₊ₓMn_{2-x-y}M_{y}O₄ blended with Li₁₊ₓNiₐMn_{b}Co_{c}O₂ to have a weight percentage of Li₁₊ₓMn_{2-x-y}M_{y}O₄ ranging between 0% to 100%.
